(19) United States
(12) Patent Application Publication
(10) Pub. No.: US 2013/0132195 A1
(43) Pub. Date: May 23, 2013

(54) METHODS AND SYSTEMS FOR CREATING DYNAMIC USER SEGMENTS BASED ON SOCIAL GRAPHS

(71) Applicants: Aaron J. Klish, St. Joseph, IL (US); Greg Muchnik, Champaign, IL (US); Matthew Ahrens, Champaign, IL (US)

(72) Inventors: Aaron J. Klish, St. Joseph, IL (US); Greg Muchnik, Champaign, IL (US); Matthew Ahrens, Champaign, IL (US)

(73) Assignee: Yahoo! Inc., Sunnyvale, CA (US)

(21) Appl. No.: 13/302,608

(22) Filed: Nov. 22, 2011

(51) Int. Cl. G06Q 30/02; G06N 5/00

(52) U.S. Cl. 705/14.52; 706/45

(57) ABSTRACT

Techniques are provided which allow classifying users into targeting segments. Methods and systems obtain a user's social graph, which indicates the user's social network connections. A first group of targeting segments that each of the user's social network connections belong to may be determined. A second group of targeting segments, which includes targeting segments that the user does not currently belong to, may be determined from the first group of targeting segments. A confidence rating may be assigned to each of the targeting segments in the second group. The user may be classified into one or more of the targeting segments in the second group of targeting segments based at least in part on the confidence rating.

### BACKGROUND

Advertisers (including proxies, agents, or other entities acting on behalf of or in the interest of advertisers) compete for user attention. By effective referencing and use of topics of interest in their advertising, advertisers grab attention, build rapport with audiences, and increase brand cachet. For example, in maintaining distinctiveness and relevance, advertisers benefit from, among other things, knowledge of interests and trending interests of their target audiences.

One particular way for advertisers to target users is to categorize users into segments based on internet browsing history. However, this limits the categorization to be dependent on what the user has already done. There is a need for more predictive techniques for use in, among other things, categorizing users into user segments to allow advertisers to target more users for a particular segment.

### SUMMARY

Exemplary embodiments of the invention provide systems and methods which allow classifying users into targeting segments. In some embodiments, a user's social graph may be obtained, wherein the social graph comprises at least the user's social network connections. For example, the social graph may include, among other things, the user's social network connections (direct and indirect), the targeting segments that each of the connections is a part of, the type of device they use (e.g., make and model of smartphone, tablet, laptop, etc.), and browsing history of sites visited.

A first group of targeting segments that each of the user's social network connections belong to may be determined. In other words, it is determined which targeting segments the user's social network connections (direct and indirect) belong to.

A second group of targeting segments is determined from the first group of targeting segments, wherein the second group of targeting segments comprises targeting segments that the user does not currently belong to. In accordance with an exemplary embodiment, the first group of targeting segments, which includes the targeting segments that the user's social network connections belong to, is compared to the targeting segments that the user belongs to. The second group of targeting segments includes the targeting segments that the user does not belong to, but which the user's social networking connections do. For example, if the user belongs to targeting segments 1, 2 and 3, and the user's social networking connections collectively belong to segments 2, 4 and 5, the first group of targeting segments would include segments 2, 4 and 5 and the second group of targeting segments would include segments 4 and 5.

The user maybe classified into the second group of targeting segments. Using the above example, the user would be classified into targeting segments 4 and 5. In some embodiments, a confidence rating may be assigned to each targeting segment in the second group of targeting segments. Using the above example, a confidence rating may be assigned to each of segments 4 and 5. The confidence rating may be, for example, a flag (e.g., designated as high or low), or a numerical rating (e.g., a range or a percentage). The confidence rating may be based on a number of factors (alone or in combination) such as for example, number of the user's connections who are also classified into that segment, the strength of connection between the user and the connections that are classified into that segment (e.g., degrees of separation or social graph distance from the user), the type of device(s) used by the connections who are classified into that segment, the type of browser used by the connections who are classified into that segment, the browsing history of the connections, etc.

### BRIEF DESCRIPTION OF THE DRAWINGS

FIG. 1 is a distributed computer system according to one embodiment of the invention;

FIG. 2 is a flow diagram illustrating a method according to one embodiment of the invention;

FIG. 3 is a flow diagram illustrating a method according to one embodiment of the invention;

FIG. 4 is a flow diagram illustrating a method according to one embodiment of the invention; and

FIG. 5 is a diagram illustrating an exemplary social graph in accordance with one embodiment of the invention.

### DETAILED DESCRIPTION

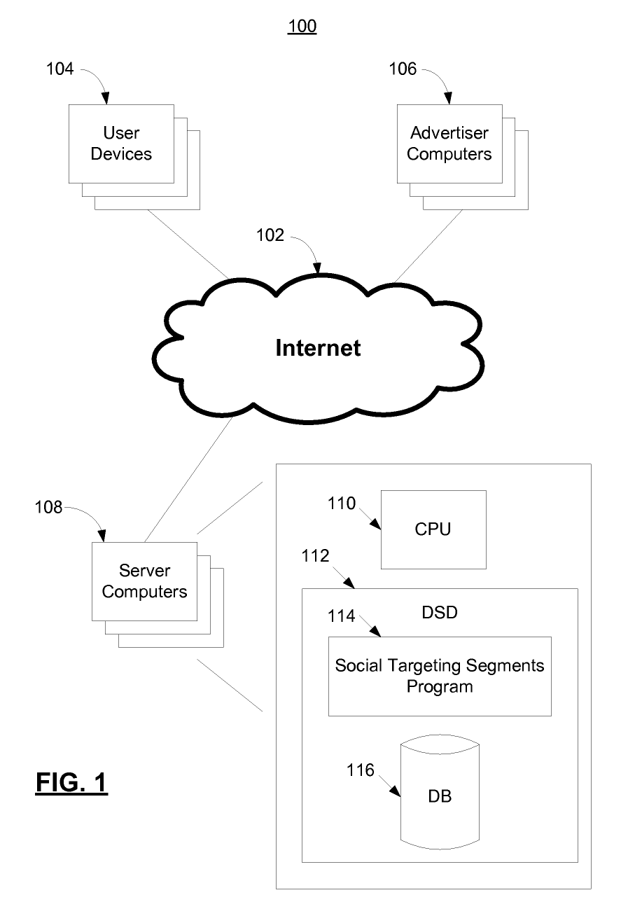

FIG. 1 is a distributed computer system 100 according to one embodiment of the invention. The system 100 includes user devices 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user devices 104 may be or include smart televisions (e.g., televisions with internet connectivity), non-smart televisions, set-top boxes, gaming consoles, desktop or laptop PCs, as well as, wireless, mobile, or handheld devices such as cell phones (including smart phones), PDAs, tablets, etc.

Each of the one or more computers 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Social Targeting Segments Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

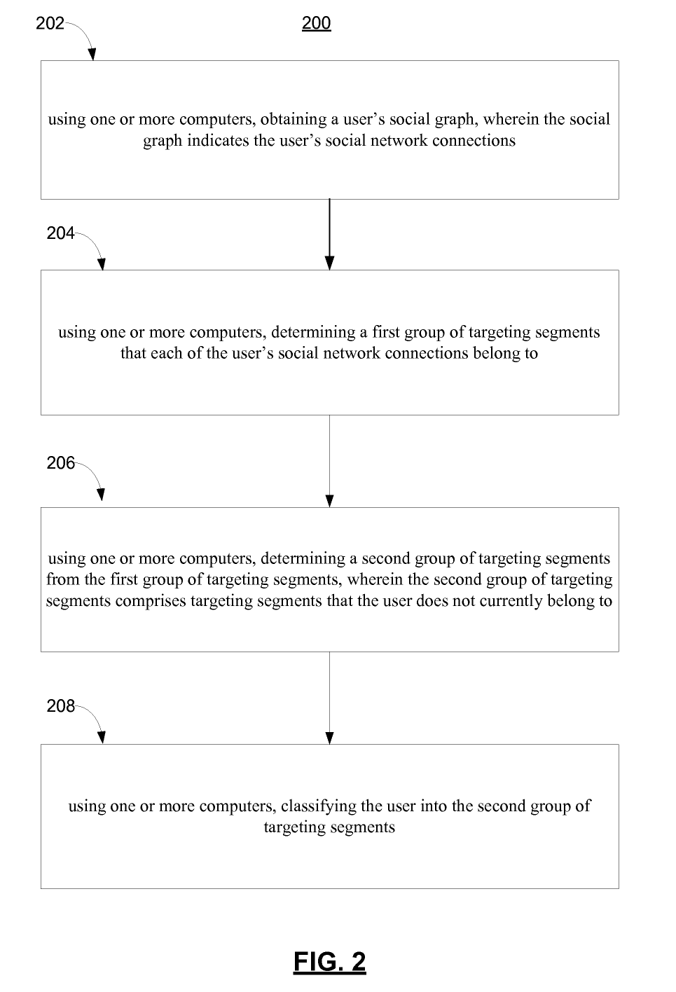

FIG. 2 is a flow diagram illustrating a method 200 according to one embodiment of the invention. At step 202 using one or more computers, a user's social graph may be obtained, wherein the social graph indicates the user's social network connections. For example, the social graph may include, among other things, the user's social network connections (direct and indirect), the targeting segments that each of the connections is a part of, the type of device they use (e.g., make and model of smartphone, tablet, laptop, etc.), and browsing history of sites visited.

At step 204, using one or more computers, a first group of targeting segments that each of the user's social network connections belong to may be determined. In other words, it is determined which targeting segments the user's social network connections (direct and indirect) belong to.

At step 206, using one or more computers, a second group of targeting segments is determined from the first group of targeting segments, wherein the second group of targeting segments comprises targeting segments that the user does not currently belong to. In accordance with an exemplary embodiment, the first group of targeting segments, which includes the targeting segments that the user's social network connections belong to, is compared to the targeting segments that the user belongs to. The second group of targeting segments includes the targeting segments that the user does not belong to, but which the user's social networking connections do. For example, if the user belongs to targeting segments 1, 2 and 3, and the user's social networking connections collectively belong to segments 2, 4 and 5, the first group of targeting segments would include segments 2, 4 and 5 and the second group of targeting segments would include segments 4 and 5.

At step 208, using one or more computers, the user maybe classified into the second group of targeting segments. Using the above example, the user would be classified into targeting segments 4 and 5.

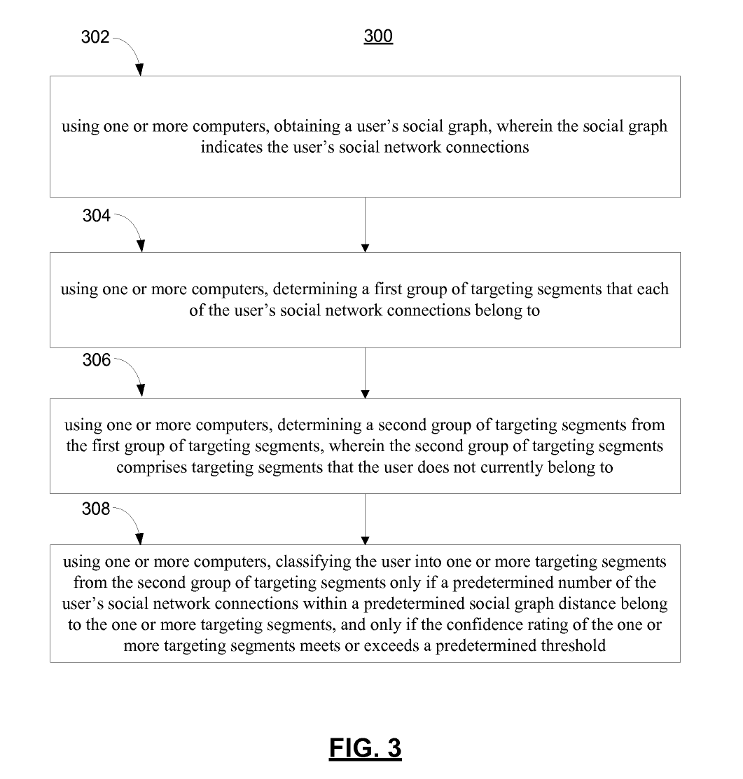

FIG. 3 is a flow diagram illustrating a method 300 according to one embodiment of the invention. At step 302 using one or more computers, a user's social graph may be obtained, wherein the social graph indicates the user's social network connections. For example, the social graph may include, among other things, the user's social network connections (direct and indirect), the targeting segments that each of the connections is a part of, the type of device they use (e.g., make and model of smartphone, tablet, laptop, etc.), and browsing history of sites visited.

At step 304, using one or more computers, a first group of targeting segments that each of the user's social network connections belong to may be determined. In other words, it is determined which targeting segments the user's social network connections (direct and indirect) belong to. At step 306, using one or more computers, a second group of targeting segments is determined from the first group of targeting segments, wherein the second group of targeting segments comprises targeting segments that the user does not currently belong to. In accordance with an exemplary embodiment, the first group of targeting segments, which includes the targeting segments that the user's social network connections belong to, is compared to the targeting segments that the user belongs to. The second group of targeting segments includes the targeting segments that the user does not belong to, but which the user's social networking connections do.

At step 308, using one or more computers the user may be classified into one or more targeting segments from the second group of targeting segments only if a predetermined number of the user's social network connections within a predetermined social graph distance belong to the one or more targeting segments, and only if the confidence rating of the one or more targeting segments meets or exceeds a predetermined threshold. In accordance with an exemplary embodiment, the user will only be classified into the connections' targeting segments if a predetermined number of connections within a predetermined social graph distance belong to the targeting segments. For example, the algorithm may be set such that a user will only be classified into one or more targeting segments that the user's social network connections belong to if at least 25% of the user's social network connections also belong to the targeting segments and if those connections are within two degrees from the user.

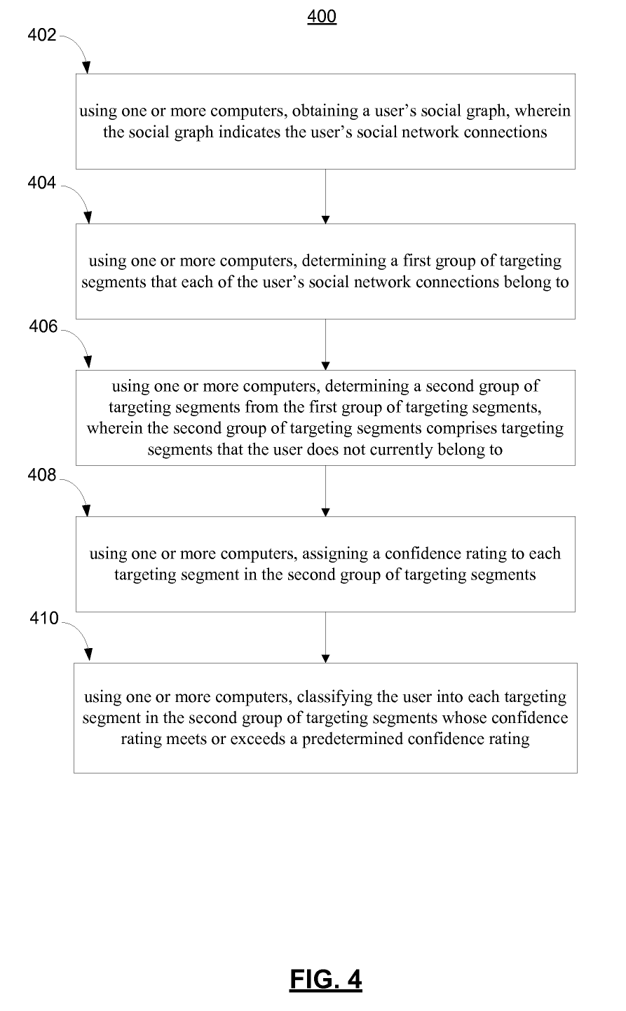

FIG. 4 is a flow diagram illustrating a method 400 according to one embodiment of the invention. At step 402 using one or more computers, a user's social graph may be obtained, wherein the social graph indicates the user's social network connections. For example, the social graph may include, among other things, the user's social network connections (direct and indirect), the targeting segments that each of the connections is a part of, the type of device they use (e.g., make and model of smartphone, tablet, laptop, etc.), and browsing history of sites visited.

At step 404, using one or more computers, a first group of targeting segments that each of the user's social network connections belong to may be determined. In other words, it is determined which targeting segments the user's social network connections (direct and indirect) belong to. At step 406, using one or more computers, a second group of targeting segments is determined from the first group of targeting segments, wherein the second group of targeting segments comprises targeting segments that the user does not currently belong to. In accordance with an exemplary embodiment, the first group of targeting segments, which includes the targeting segments that the user's social network connections belong to, is compared to the targeting segments that the user belongs to. The second group of targeting segments includes the targeting segments that the user does not belong to, but which the user's social networking connections do.

At step 408, using one or more computers, a confidence rating may be assigned to each targeting segment in the second group of targeting segments. Using the example from the description of FIG. 2 above, a confidence rating may be assigned to each of segments 4 and 5. The confidence rating may be, for example, a flag (e.g., designated as high or low), or a numerical rating (e.g., a range or a percentage). The confidence rating may be based on a number of factors (alone or in combination) such as for example, number of the user's connections who are also classified into that segment, the strength of connection between the user and the connections that are classified into that segment (e.g., degrees of separation or social graph distance from the user), the type of device(s) used by the connections who are classified into that segment, the type of browser used by the connections who are classified into that segment, the browsing history of the connections, etc.

At step 410, using one or more computers, the user may be classified into each targeting segment in the second group of targeting segments whose confidence rating meets or exceeds a predetermined confidence rating. For example, it may be determined that users are only classified into segments if the confidence rating is greater than or equal to 50%. In accordance with one embodiment, one or more advertisements to be served to the user may be selected based at least in part on the targeting segments that the user is now classified into, and/or based on the confidence rating assigned to those segments. For example, even though a user may have been classified into a targeting segment with a confidence rating of 50%, am advertiser may only wish to advertise to users in targeting segments with confidence ratings of at least 75%.

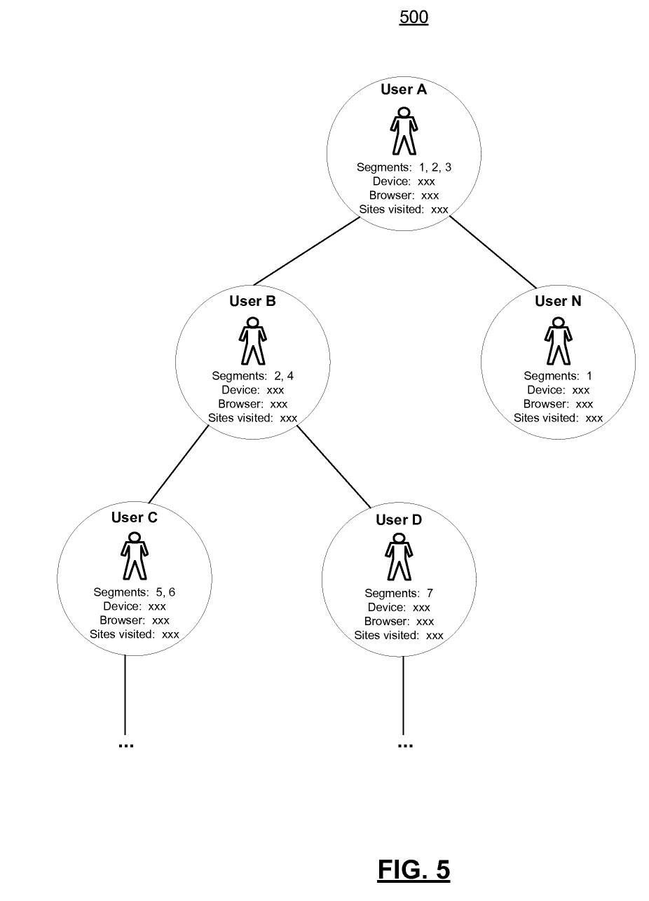

FIG. 5 is a diagram 500 illustrating an exemplary social graph in accordance with one embodiment of the invention. As depicted in FIG. 5, the social graph may include various types of information relating to a user's social network connections. For example, the social graph may indicate the targeting segments a user is a part of, the type of device used by the user, the type of browser used by the user, the user's browsing history, etc. In addition, the social graph may also be used to determine the strength of a user's connections. For example, User A's connection to User B is stronger than User A's connection to Users C and D because the social graph distance (or degree of separation) from User A to User B is shorter (1) than it is from User A to Users C and D (2).

Using the exemplary social graph of FIG. 5, User A is already classified into segments 1, 2, and 3, and User A's connections belong to some segments that User A is not currently classified into (segments 4, 5, 6, and 7). Thus, a confidence rating may be assigned to each of segments 4, 5, 6, and 7 based on the factors discussed above. Segments 5, 6 and 7 may have low confidence ratings initially because Users C and D are not directly connected to User A, or in other words, they are a greater social graph distance away from User A. However, if User A makes additional connections which are also classified into segments 5, 6, and 7, the confidence rating may increase enough for User A to be classified into those segments. In some embodiments, if User A has additional factors in common with connections, this may also increase the confidence rating. For example, even though Users C and D are two degrees of separation away from User A (resulting in a lower confidence rating), if User A and Users C and D had similar browsing histories and/or used the same device, the confidence rating may increase. On the contrary, if for example, User B has nothing in common with User A, it may be determined that User A likely does not have the same interests as User B and should not be classified into segment 2, and as a result, segment 2 may receive a low confidence rating. It should be noted that the scenarios described above are merely exemplary, and any number of factors may be used alone or in combination to designate confidence ratings to targeting segments.

While the invention is described with reference to the above drawings, the drawings are intended to be illustrative, and the invention contemplates other embodiments within the spirit of the invention.

1. A method comprising:
using one or more computers, obtaining a user's social graph, wherein the social graph comprises at least the user's social network connections;
using one or more computers, determining a first group of targeting segments that each of the user's social network connections belong to;
using one or more computers, determining a second group of targeting segments from the first group of targeting segments, wherein the second group of targeting segments comprises targeting segments that the user does not currently belong to; and
using one or more computers, classifying the user into the second group of targeting segments.

2. The method of claim 1, further comprising:
using one or more computers, assigning a confidence rating to each targeting segment in the second group of targeting segments.

3. The method of claim 2, wherein the confidence rating is a flag.

4. The method of claim 2, wherein the confidence rating is a numerical rating.

5. The method of claim 2, further comprising:
using one or more computers, selecting one or more advertisements to be served to the user based at least in part on one or more targeting segments of the second group of targeting segments.

6. The method of claim 5, further comprising:
using one or more computers, selecting one or more advertisements to be served to the user based at least in part on the confidence rating.

7. The method of claim 2, wherein the confidence rating is based at least in part on strength of connection between the user and the corresponding social network connection.

8. The method of claim 2, wherein the confidence rating is based at least in part on a type of mobile device used by the user and the corresponding social network connection.

9. The method of claim 2, wherein the confidence rating is based at least in part on a type of browser used the user and the corresponding social network connection.

10. A system comprising:
one or more server computers coupled to a network; and
one or more databases coupled to the one or more server computers;
wherein the one or more server computers are for:
obtaining a user's social graph, wherein the social graph comprises at least the user's social network connections;
determining a first group of targeting segments that each of the user's social network connections belong to;
determining a second group of targeting segments from the first group of targeting segments, wherein the second group of targeting segments comprises targeting segments that the user does not currently belong to; and
classifying the user into the second group of targeting segments.

11. The system of claim 1, wherein the one or more server computers are further configured for:
assigning a confidence rating to each targeting segment in the second group of targeting segments.

12. The system of claim 11, wherein the confidence rating is a flag.

13. The system of claim 11, wherein the confidence rating is a numerical rating.

14. The system of claim 11, wherein the one or more server computers are further configured for:
selecting one or more advertisements to be served to the user based at least in part on one or more targeting segments of the second group of targeting segments.

15. The system of claim 14, wherein the one or more server computers are further configured for:
selecting one or more advertisements to be served to the user based at least in part on the confidence rating.

16. The system of claim 11, wherein the confidence rating is based at least in part on strength of connection between the user and the corresponding social network connection.

17. The system of claim 11, wherein the confidence rating is based at least in part on a type of mobile device used by the user and the corresponding social network connection.

18. The system of claim 11, wherein the confidence rating is based at least in part on a type of browser used the user and the corresponding social network connection.

19. The system of claim 11, wherein classifying the user into the second group of targeting segments further comprises classifying the user into one or more targeting segments from the second group of targeting segments only if a predetermined number of the user's social network connections within a predetermined social graph distance belong to the one or more targeting segments.

20. A computer readable medium or media containing instructions for executing a method comprising:
using one or more computers, obtaining a user's social graph, wherein the social graph comprises at least the user's social network connections and one or more targeting segments that each respective connection belongs to;
using one or more computers, determining, based at least in part on the social graph, a first group of targeting segments that each of the user's social network connections belong to;
using one or more computers, determining a second group of targeting segments from the first group of targeting segments, wherein the second group of targeting segments comprises targeting segments that the user does not currently belong to;
using one or more computers, assigning a confidence rating to each targeting segment in the second group of targeting segments;
using one or more computers, classifying the user into one or more targeting segments from the second group of targeting segments only if a predetermined number of the user's social network connections within a predetermined social graph distance belong to the one or more targeting segments, and only if the confidence rating of the one or more targeting segments meets or exceeds a predetermined threshold.
